(19) United States
(12) Patent Application Publication
(10) Pub. No.: US 2025/0016733 A1
(43) Pub. Date: Jan. 9, 2025

(54) METHOD AND APPARATUS FOR WIRELESS SENSING

(71) Applicant: LENOVO (BEIJING) LIMITED, Beijing (CN)

(72) Inventors: Jianfeng WANG, Beijing (CN); Lianhai WU, Beijing (CN); Bingchao LIU, Beijing (CN); Tingfang TANG, Beijing (CN)

(21) Appl. No.: 18/713,385

(22) PCT Filed: Nov. 26, 2021
(86) PCT No.: PCT/CN2021/133612

§ 371 Date: May 24, 2024

(51) Int. Cl. H04W 64/00; H04L 5/00; H04W 76/27

(52) U.S. Cl. CPC H04W 64/006; H04L 5/0055; H04W 76/27

(57) ABSTRACT

Embodiments of the present disclosure relate to a method and apparatus for wireless sensing. According to some embodiments of the disclosure, a user equipment (UE) may receive, from a base station (BS), a request to assist sensing, wherein the request indicates a target area in which the sensing is to be performed; and transmit, to the BS, a sensing signal in response to determining to accept the request.

### TECHNICAL FIELD

Embodiments of the present disclosure generally relate to communication technology, and more particularly to wireless sensing in a wireless communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

The radio information obtained during signal processing can be used to detect environmental changes caused by, for example, motion of objects and people. Such process can be referred to as radio sensing or wireless sensing, similar to radar. Some examples of ubiquitous radio sensing services may include safe autonomous vehicles, unmanned aerial vehicles (UAVs), environment mapping to improve positioning accuracy and enable environment related applications, real-time monitoring for intrusion detection, etc. Introducing sensing capability into, for example, a wireless communication system may have the benefit of sharing the same spectrum and infrastructure especially in the industry with both communication and sensing, which is one of the promising wireless communication techniques.

Therefore, it is desirable to introduce such sensing function into a wireless communication system such as a 5G system.

### SUMMARY

Some embodiments of the present disclosure provide a user equipment (UE). The UE may include: a transceiver; and a processor coupled to the transceiver. The processor may be configured to: receive, from a base station (BS), a request to assist sensing, wherein the request indicates a target area in which the sensing is to be performed; and transmit, to the BS, a sensing signal in response to determining to accept the request.

In some embodiments of the present disclosure, the request may be received via a paging message in response to the UE being in an inactive or idle mode. In some embodiments, the processor may be further configured to perform a random access procedure to switch the UE from the inactive or idle mode to a connected mode in response to determining to accept the request. Transmitting the sensing signal may include transmitting the sensing signal when the UE is in the connected mode. The processor may be further configured to transmit an acknowledgement (ACK) message to the BS in response to determining to accept the request. The ACK message may indicate a sensing capability of the UE.

In some embodiments of the present disclosure, the processor may be further configured to receive a configuration for the sensing signal from the BS. Transmitting the sensing signal may include transmitting the sensing signal according to the configuration for the sensing signal.

In some embodiments of the present disclosure, the sensing signal may include an uplink reference signal (RS). The configuration for the sensing signal may include at least one of the following: bandwidth information of the uplink RS; a transmission pattern of the uplink RS; or periodicity information of the uplink RS.

In some embodiments of the present disclosure, the configuration for the sensing signal may indicate a value of a timer to terminate the sensing or a threshold of a counter to terminate the sensing. The processor may be further configured to terminate the sensing according to the configured value of the timer or the configured threshold of the counter.

Some embodiments of the present disclosure provide a base station (BS). The BS may include: a transceiver; and a processor coupled to the transceiver. The processor may be configured to: transmit, to a user equipment (UE), a request to assist sensing, wherein the request indicates a target area in which the sensing is to be performed; and receive, from the UE, a sensing signal in response to the transmission of the request.

In some embodiments of the present disclosure, the request may be transmitted via a paging message in response to the UE being in an inactive or idle mode. In some embodiments of the present disclosure, the processor may be further configured to perform a random access procedure to switch the UE from the inactive or idle mode to a connected mode. Receiving the sensing signal may include receiving the sensing signal when the UE is in the connected mode. In some embodiments of the present disclosure, the processor may be further configured to receive an uplink synchronization signal from the UE in response to the request. Receiving the sensing signal may include receiving the sensing signal when the UE is in the inactive or idle mode.

In some embodiments of the present disclosure, the processor may be further configured to transmit a configuration for the sensing signal to the UE. Receiving the sensing signal may include receiving the sensing signal according to the configuration for the sensing signal.

In some embodiments of the present disclosure, the sensing signal may include an uplink reference signal (RS). The configuration for the sensing signal may include at least one of the following: bandwidth information of the uplink RS: a transmission pattern of the uplink RS: or periodicity information of the uplink RS.

In some embodiments of the present disclosure, the configuration for the sensing signal may indicate a value of a timer to terminate the sensing or a threshold of a counter to terminate the sensing.

Some embodiments of the present disclosure provide a method performed by a UE. The method may include: receiving, from a base station (BS), a request to assist sensing, wherein the request indicates a target area in which the sensing is to be performed; and transmitting, to the BS, a sensing signal in response to determining to accept the request.

Some embodiments of the present disclosure provide a method performed by a BS. The method may include: transmitting, to a user equipment (UE), a request to assist sensing, wherein the request indicates a target area in which the sensing is to be performed; and receiving from the UE, a sensing signal in response to the transmission of the request.

Some embodiments of the present disclosure provide an apparatus. According to some embodiments of the present disclosure, the apparatus may include: at least one non-transitory computer-readable medium having stored thereon computer-executable instructions: at least one receiving circuitry: at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present application provide a technical solution for improving network performance, which can facilitate and improve the implementation of various communication technologies.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure:

FIG. 2 illustrates a flow chart of an exemplary procedure of wireless communications in accordance with some embodiments of the present disclosure:

FIG. 3 illustrates a flow chart of an exemplary procedure of wireless communications in accordance with some embodiments of the present disclosure:

FIG. 4 illustrates a flow chart of an exemplary procedure of wireless communications in accordance with some embodiments of the present disclosure:

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

With the development of communication technologies, a sensing function or sensing ability is proposed to be introduced to the 3GPP. Embodiments of the present disclosure provide solutions for enabling wireless sensing in a wireless communication system. For example, in some embodiments of the present disclosure, a BS may perform sensing with the assistance of a UE(s). For instance, one or more serving UEs of the BS may be selected to send uplink signals to the BS to assist sensing. Enhancements on the interface between the UEs and BS (e.g., Uu interface) may be needed to enable the sensing function. Embodiments of the present disclosure provide signaling and procedures to enable the sensing function.

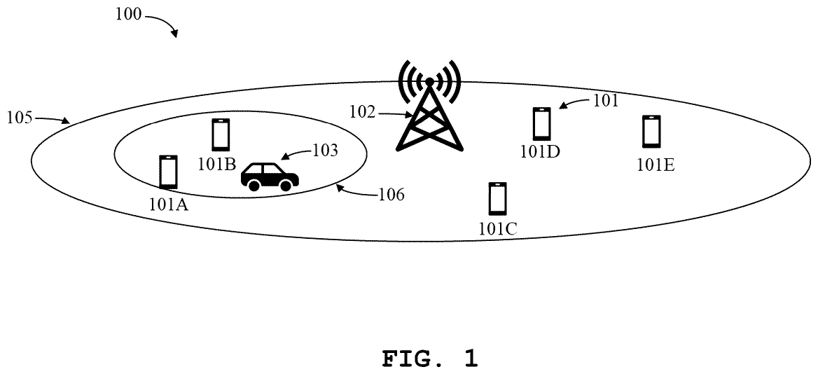

FIG. 1 illustrates a schematic diagram of a wireless communication system 100 in accordance with some embodiments of the present disclosure.

As shown in FIG. 1, a wireless communication system 100 may include a base station (e.g., BS 102) and some UEs 101 (e.g., UEs 101A-101E) located within the coverage area 105 of BS 102. Although a specific number of UE 101 and BS 102 is depicted in FIG. 1, it is contemplated that any number of UEs and BSs may be included in the wireless communication system 100.

UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE 101 includes wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 101 may communicate with BS 102 via uplink (UL) communication signals.

UE 101 may be in one of the following states: an RRC-IDLE state, an RRC_CONNECTED state, or an RRC_INACTIVE state, at a given time. The UE may be in an idle mode corresponding to the RRC_IDLE state, an inactive mode corresponding to the RRC_INACTIVE state, or a connected mode corresponding to the RRC_CONNECTED state. The specific characteristics of the RRC-IDLE state, RRC_CONNECTED state, and RRC_INACTIVE state are defined in 3GPP specifications.

BS 102 may be distributed over a geographic region. In certain embodiments of the present disclosure, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally a part of a radio access network that may include one or more controllers communicably coupled to one or more corresponding BSs 102. BS 102 may communicate with UE 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 102 and UE 101 may communicate using other communication protocols, such as the IEEE 802.11 family of wireless communication protocols. Further, in some embodiments of the present disclosure, BS 102 and UE 101 may communicate over licensed spectrums, whereas in some other embodiments, BS 102 and UE 101 may communicate over unlicensed spectrums. The present disclosure is not intended to be limited to the implementation of any particular wireless communication system architecture or protocol.

In some embodiments of the present disclosure, BS 102 may want to sense vehicle (e.g., a car) 103 in the sensing area 106. For example, BS 102 may want to acquire the position, speed and lane occupying information of vehicle 103. In some examples, BS 102 may select UEs 101A and 101B to assist the sensing since UEs 101A and 101B are within sensing area 106. UEs 101A and 101B may transmit corresponding signals to BS 102 for the sensing.

Embodiments of the present disclosure provide various solutions to support UE-assisted BS sensing. More details on the embodiments of the present disclosure will be illustrated in the following text in combination with the appended drawings.

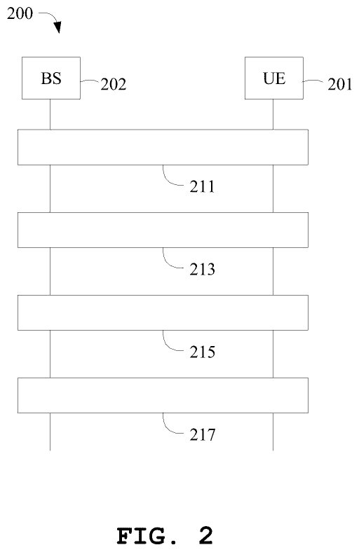

FIG. 2 illustrates a flow chart of an exemplary procedure 200 of wireless communications in accordance with some embodiments of the present disclosure. Details described in all of the foregoing embodiments of the present disclosure are applicable for the embodiments shown in FIG. 2.

Procedure 200 illustrates a general procedure to support UE-assisted BS sensing. The procedure may be performed per a sensing area. Referring to FIG. 2, UE 201 and BS 202 may function as UE 101 and BS 102 shown in FIG. 1, respectively.

In operation 211, BS 202 may determine which UE(s) is in the target sensing area. Such determination can be made according to various methods. For example, BS 202 may request UEs within its coverage to report their positions. For example, BS 202 may determine a UE's position according to various techniques, such as the global position system (GPS). BS 202 may select one or more UEs (e.g., UE 201) to assist the sensing.

In operation 213, BS 202 may perform an initiating procedure to negotiate with the selected UE (e.g., UE 201). In operation 215, BS 202 and UE 201 may perform a sensing signal transmission procedure. For example, in response to being synchronized with BS 202, UE 201 may transmit the sensing signal to BS 202 until the termination of the sensing procedure. In operation 217, the sensing procedure may be terminated.

It should be appreciated by persons skilled in the art that the sequence of the operations in exemplary procedure 200 may be changed and some of the operations in exemplary procedure 200 may be eliminated or modified, without departing from the spirit and scope of the disclosure.

According to the different states (e.g., RRC_CONNECTED, RRC_IDLE and RRC_INACTIVE states) of the selected UEs, different signaling and procedures may be required to support the sensing function.

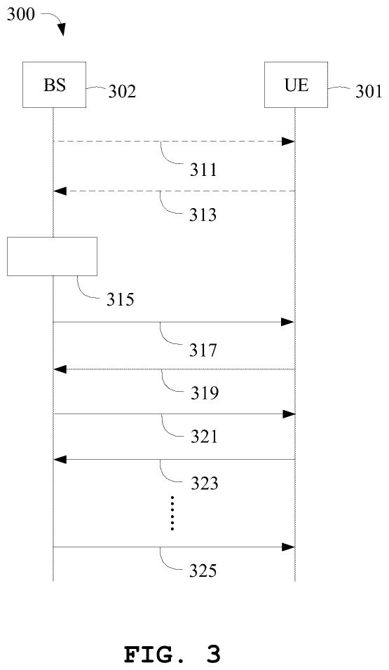

FIG. 3 illustrates a flow chart of an exemplary procedure 300 of wireless communications in accordance with some embodiments of the present disclosure. Details described in all of the foregoing embodiments of the present disclosure are applicable for the embodiments shown in FIG. 3. Procedure 300 may be applied to a UE in the connected mode.

Referring to FIG. 3, UE 301 and BS 302 may function as UE 101 and BS 102 shown in FIG. 1, respectively. BS 302 may want to perform sensing in a target sensing area. BS 302 may select UEs in the sensing area to assist the sensing. In some examples, BS 302 may request UEs connected to BS 302 to report position-related information.

For example, in operation 311 (denoted by dotted arrow as an option), BS 302 may request UE 301 to report position-related information. In operation 313 (denoted by dotted arrow as an option), UE 301 may report the position-related information to BS 302. In this way, BS 302 can determine the position of UE 301. It should be appreciated that BS 302 may determine a UE's position according to other methods.

In some examples, BS 302 may receive a sensing request from the upper layer. In operation 315, BS 302 may select the UE(s) to assist the sensing. The selection may be based on a selection criterion. In some examples, BS 302 may select the UE(s) according to the position information of the UE(s). For instance, a UE within the target sensing area can be selected. In some examples, BS 302 may take signal strength into consideration. For instance, BS 302 may select the UEs based on the signal strength between the UEs and BS 302. For example, when the signal strength between a UE within the target sensing area and BS 302 is greater than or equal to a threshold, BS 302 may select this UE. Other selection criteria or any combination thereof may be employed.

BS 302 may request the selected UEs to send sensing signals. For example, in operation 317, BS 302 may transmit a request to UE 301 to assist sensing. The request may indicate a target area in which the sensing is to be performed. In some examples, the request may be transmitted via an RRC signaling message dedicated for the sensing function. The requested sensing signal may include various signals, for example, an uplink reference signal (RS) such as a sounding RS (SRS) or other signals designed specifically for the sensing function.

In response to receiving the request, UE 301 may determine whether to accept the request. In some examples, UE 301 may determine whether to accept the request based on the indicated target area and the location of UE 301. For example, when UE 301 is within the target area, it may accept the request: otherwise, UE 301 may reject the request by, for example, not performing the following operations as shown in FIG. 3.

In response to determining to accept the request, UE 301 may, in operation 319, transmit an acknowledgement (ACK) message to BS 302. In some examples, the ACK message may indicate a sensing capability of UE 301. The sensing capability may refer to the capability to transmit the sensing signal to satisfy the expected sensing function. For example, the request to send the sensing signal from the BS may require a specific type of sensing signal, whereby the ACK message may indicate whether such sensing signal is supported or not at the UE. For example, the UE may notify the BS of the types of sensing signal(s) that are supported by the UE.

In response to receiving the ACK message, BS 302 may, in operation 321, transmit the configuration for the sensing signal to UE 301. In some examples, the configuration may be carried by an RRC signaling message dedicated for the sensing function. For example, the sensing signal may include an uplink RS (e.g., SRS). For example, the configuration for the sensing signal may include time and frequency domain information for the sensing signal. For example, the configuration for the sensing signal may include at least one of: bandwidth information of the sensing signal; a transmission pattern of the sensing signal: or periodicity information of the sensing signal.

In operation 323, UE 301 may transmit the sensing signal to BS 302 according to the configuration for the sensing signal. The sensing signal may include various signals, for example, an uplink RS such as an SRS or other signals designed specifically for the sensing function.

BS 302 may receive and process the sensing signal to derive the sensing data, including, for example, channel state information (CSI) or receive signal strength (RSS), which can be used to further derive the sensing results, such as the position and speed of the sensing target.

In some examples, UE 301 may repeatedly transmit the sensing signal to BS 302 until the termination of the sensing procedure. In some examples, UE 301 may terminate the sensing in response to BS 302 transmitting a termination indication to UE 301 in operation 325. In some examples, UE 301 may terminate the sensing when UE 301 leaves the target area.

In some examples, the configuration for the sensing signal may indicate a value of a timer to terminate the sensing or a threshold of a counter to terminate the sensing. UE 301 may terminate the sensing according to the configured value of the timer or the configured threshold of the counter. For instance, UE 301 may start a timer in response to receiving the configuration and may terminate the sensing in response to the expiry of the timer. For instance, UE 301 may initiate a counter in response to receiving the configuration. The counter may be a count-up counter, where the value of the counter is set as a specific start count (e.g., zero) during the initiation and is increased by one count (e.g., increment by +1) when a sensing signal is transmitted until a specific end count (e.g., the threshold of the counter) is met. The counter may be a count-down counter, where the value of the counter is set as a specific start count (e.g., the threshold of the counter) during the initiation and is decreased by one count (e.g., increment by −1) when a sensing signal is transmitted until a specific end count (e.g., zero) is met.

With the above procedure, the sensing procedure can be accomplished in a radio access network (RAN) with the assistance of the connected UE(s). It should be appreciated by persons skilled in the art that the sequence of the operations in exemplary procedure 300 may be changed and some of the operations in exemplary procedure 300 may be eliminated or modified, without departing from the spirit and scope of the disclosure.

In some examples, the UEs selected for sensing may always be assumed to be in a connected mode. For example, a BS may only select a connected UE to assist the sensing. However, since a UE may always be in the idle or inactive mode when there is no data for transmission to save power, it would be beneficial to allow the idle or inactive UEs to be selected. Exemplary procedures for an idle or inactive UE to support the sensing function will be described in detail below.

In some examples, the idle or inactive UE may switch to the connected mode to assist the sensing.

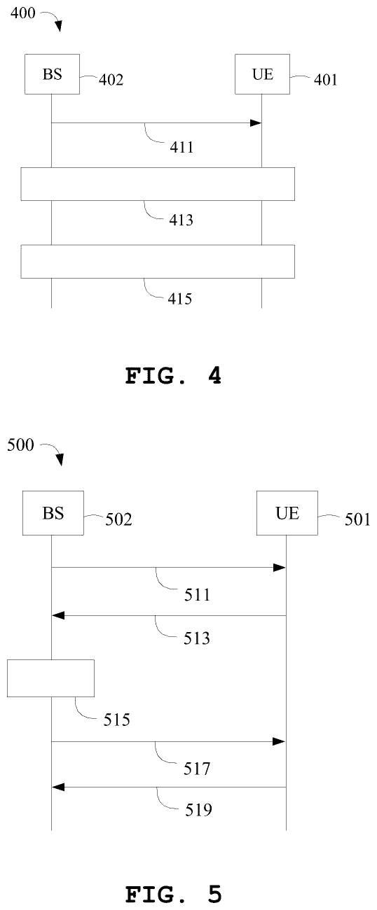

FIG. 4 illustrates a flow chart of an exemplary procedure 400 of wireless communications in accordance with some embodiments of the present disclosure. Details described in all of the foregoing embodiments of the present disclosure are applicable for the embodiments shown in FIG. 4. Procedure 400 may be applied to a UE in the idle or inactive mode. In response to receiving the sensing request, the idle or inactive UE may switch to the connected mode by, for example, a random access procedure.

Referring to FIG. 4, UE 401 and BS 402 may function as UE 101 and BS 102 shown in FIG. 1, respectively. BS 402 may want to perform sensing in a target sensing area. BS 402 may request idle or inactive UEs in the target sensing area to send assist sensing. For example, BS 402 may receive a sensing request from the upper layer. In operation 411, BS 402 may transmit a paging message to request the idle or inactive UE(s) to assist sensing. In some examples, the paging message may be a dedicated paging message for the sensing function. In some examples, the paging message may indicate at least one of: the purpose of the paging (for example, to assist sensing with a dedicated signal transmission), or the target area in which the sensing is to be performed.

UE 401 may receive the paging message. In response to receiving the paging message, UE 401 may determine whether to accept the request. In some examples, UE 401 may determine whether to accept the request based on the target area information indicated in the request. For example, when UE 401 is within the target area, it may accept the request: otherwise, UE 401 may reject the request by, for example, not performing the following operations as shown in FIG. 4. In some examples, BS 402 may know the position of an idle or inactive UE via some other methods. In these examples, BS 402 may directly select and page this UE.

In response to determining to accept the request, UE 401 may, in operation 413, perform a random access procedure to switch UE 401 from the inactive or idle mode to the connected mode. In response to a successful random access procedure, UE 401 may switch to the connected mode. UE 401 may then perform a sensing signal transmission procedure similar to that of procedure 300 (e.g., operations 321-325) in operation 415 to transmit the sensing signal to BS 402. For example, BS 402 may transmit a configuration for the sensing signal to UE 401. UE 401 may transmit the sensing signal to BS 402 according to the configuration for the sensing signal. UE 401 may repeatedly transmit the sensing signal to BS 402 until the termination of the sensing procedure.

With the above procedure, the sensing procedure can be accomplished in a RAN with the assistance of the idle or inactive UE(s). It should be appreciated by persons skilled in the art that the sequence of the operations in exemplary procedure 400 may be changed and some of the operations in exemplary procedure 400 may be eliminated or modified, without departing from the spirit and scope of the disclosure.

In some examples, the idle or inactive UEs may not switch to the connected mode to assist the sensing.

FIG. 5 illustrates a flow chart of an exemplary procedure 500 of wireless communications in accordance with some embodiments of the present disclosure. Details described in all of the foregoing embodiments of the present disclosure are applicable for the embodiments shown in FIG. 5. Procedure 500 may be applied to a UE in the idle or inactive mode. In response to receiving the sensing request, the idle or inactive UE may transmit the requested sensing signal without the state-switch.

Referring to FIG. 5, UE 501 and BS 502 may function as UE 101 and BS 102 shown in FIG. 1, respectively. BS 502 may want to perform sensing in a target sensing area. BS 502 may request idle or inactive UEs in the target sensing area to send assist sensing. For example, BS 502 may receive a sensing request from the upper layer. In operation 511, BS 502 may transmit a paging message to request the idle or inactive UE(s) to assist sensing. In some examples, the paging message may be a dedicated paging message for the sensing function. In some examples, the paging message may indicate at least one of: the purpose of the paging (for example, to assist sensing with dedicated signal transmission), or the target area in which the sensing is to be performed.

UE 501 may receive the paging message. In response to receiving the paging message, UE 501 may determine whether to accept the request. In some examples, UE 501 may determine whether to accept the request based on the target area information indicated in the request. For example, when UE 501 is within the target area, it may accept the request: otherwise, UE 501 may reject the request by, for example, not performing the following operations as shown in FIG. 5. In some examples, BS 502 may know the position of an idle or inactive UE via some other methods. In these examples, BS 502 may directly select and page this UE.

In response to determining to accept the request, UE 501 may, in operation 513, transmit an uplink synchronization signal to BS 502. In some examples, the synchronization signal may be the random access preamble, for example, Msg. 1 of the random access procedure as defined in 3GPP specifications. In some examples, the format of the preamble can be pre-defined, indicated in the paging message, or designed specifically for the sensing function.

In operation 515, in response to the sensing request from the upper layer, BS 502 may select the UE(s) to assist the sensing. The selection may be based on a selection criterion including, for example, the position information and signal strength of the UE(s) as described above. BS 502 may select UE 501 and may, in operation 517, transmit a configuration for the sensing signal to UE 501. In some examples, the configuration may be carried by a dedicated message for the sensing function. In some examples, the configuration may be Msg.2 of the random-access procedure as defined in 3GPP specifications.

In some examples, the sensing signal may include an uplink RS (e.g., SRS) or other sensing signals. For example, the configuration for the sensing signal may include time and frequency domain information for the sensing signal. For example, the configuration for the sensing signal may include at least one of: bandwidth information of the sensing signal: a transmission pattern of the sensing signal: or periodicity information of the sensing signal.

In operation 519, UE 501 may transmit the sensing signal to BS 502 according to the configuration for the sensing signal. The sensing signal may include various signals, for example, an uplink RS such as an SRS or other signals designed specifically for the sensing function.

BS 502 may receive and process the sensing signal to derive the sensing data, including, for example, the CSI or RSS, which can be used to further derive the sensing results, such as the position and speed of the sensing target.

In some examples, UE 501 may repeatedly transmit the sensing signal to BS 502 until the termination of the sensing procedure. It should be noted that during the whole sensing procedure, UE 501 may stay in the idle or inactive mode. In some examples, the sensing procedure may be terminated under certain scenarios. For example, UE 501 may terminate the sensing when UE 501 leaves the target area. For example, the configuration for the sensing signal may indicate a value of a timer to terminate the sensing or a threshold of a counter to terminate the sensing. UE 501 may terminate the sensing according to the configured value of the timer or the configured threshold of the counter as described above with respect to FIG. 3.

With the above procedure, the sensing procedure can be accomplished in the RAN with the assistance of the idle or inactive UE(s). It should be appreciated by persons skilled in the art that the sequence of the operations in exemplary procedure 500 may be changed and some of the operations in exemplary procedure 500 may be eliminated or modified, without departing from the spirit and scope of the disclosure.

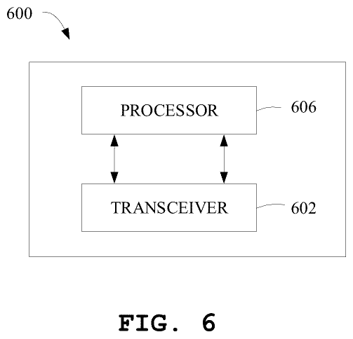

FIG. 6 illustrates a block diagram of an exemplary apparatus 600 according to some embodiments of the present disclosure. As shown in FIG. 6, the apparatus 600 may include at least one processor 606 and at least one transceiver 602 coupled to the processor 606. The apparatus 600 may be a UE or a BS.

Although in this figure elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UE described in FIGS. 1-5. In some embodiments of the present application, the apparatus 600 may be a BS. The transceiver 602 and the processor 606 may interact with each other so as to perform the operations with respect to the BS described in FIGS. 1-5.

In some embodiments of the present application, the apparatus 600 may further include at least one non-transitory computer-readable medium.

For example, in some embodiments of the present disclosure, the non-transitory computer-readable medium may have stored thereon computer-executable instructions to cause the processor 606 to implement a method(s) with respect to the UE(s) as described above. For example, the computer-executable instructions, when executed, cause the processor 606 interacting with transceiver 602 to perform the operations with respect to the UE described in FIGS. 1-5.

In some embodiments of the present disclosure, the non-transitory computer-readable medium may have stored thereon computer-executable instructions to cause the processor 606 to implement a method(s) with respect to the BS as described above. For example, the computer-executable instructions, when executed, cause the processor 606 interacting with transceiver 602 to perform the operations with respect to the BS described in FIGS. 1-5.

Those having ordinary skill in the art would understand that the operations or steps of a method(s) described in connection with the aspects disclosed herein may be embodied directly in hardware, in a software module executed by a processor, or in a combination of the two. A software module may reside in RAM memory, flash memory, ROM memory; EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive, from a base station (BS), a request to assist sensing, wherein the request indicates a target area in which the sensing is to be performed; and
transmit, to the BS, a sensing signal in response to determining to accept the request.

2. The UE of claim 1, wherein the at least one processor is configured to cause the UE to determine whether to accept the request based on the indicated target area and a location of the UE.

3. The UE of claim 1, wherein the request is received via a radio resource control (RRC) message in response to the UE being in a connected mode.

4. The UE of claim 1, wherein the request is received via a paging message in response to the UE being in an inactive mode or idle mode.

5. The UE of claim 4, wherein the at least one processor is further configured to cause the UE to transmit an uplink synchronization signal to the BS in response to determining to accept the request; and
wherein transmitting the sensing signal comprises transmitting the sensing signal when the UE is in the inactive mode or idle mode.

6. The UE of claim 3, wherein the at least one processor is further configured to cause the UE to transmit an acknowledgement (ACK) message to the BS in response to determining to accept the request, wherein the ACK message indicates a sensing capability of the UE.

7. The UE of claim 1, wherein the at least one processor is further configured to cause the UE to receive a configuration for the sensing signal from the BS; and
wherein transmitting the sensing signal comprises transmitting the sensing signal according to the configuration for the sensing signal.

8. The UE of claim 1, wherein the at least one processor is further configured to cause the UE to:
receive an indication to terminate the sensing from the BS and terminate the sensing in response to the reception of the indication; or
terminate the sensing when the UE leaves the target area.

9. A base station (BS) for wireless communication, comprising:
at least one memory; and
at least one processor coupled with the at least one memory and configured to cause the BS to:
transmit, to a user equipment (UE), a request to assist sensing, wherein the request indicates a target area in which the sensing is to be performed; and
receive, from the UE, a sensing signal in response to the transmission of the request.

10. The BS of claim 9, wherein the at least one processor is further configured to cause the BS to select the UE to assist the sensing based on a selection criterion.

11. The BS of claim 9, wherein the request is transmitted via a radio resource control (RRC) message in response to the UE being in a connected mode.

12. The BS of claim 9, wherein the request is transmitted via a paging message in response to the UE being in an inactive mode or idle mode.

13. The BS of claim 11, wherein the at least one processor is further configured to cause the BS to receive an acknowledgement (ACK) message from the BS in response to the request, wherein the ACK message indicates a sensing capability of the UE.

14. The BS of claim 9, wherein the at least one processor is further configured to cause the BS to transmit a configuration for the sensing signal to the UE; and
wherein receiving the sensing signal comprises receiving the sensing signal according to the configuration for the sensing signal.

15. The BS of claim 9, wherein the at least one processor is further configured to cause the BS to transmit an indication to terminate the sensing to the UE.

16. A processor for wireless communication, comprising:
at least controller coupled with at least one memory and configured to cause the processor to:
receive, from a base station (BS), a request to assist sensing, wherein the request indicates a target area in which the sensing is to be performed; and
transmit, to the BS, a sensing signal in response to determining to accept the request.

17. The processor of claim 16, wherein the at least one controller is configured to cause the processor to determine whether to accept the request based on the indicated target area and a location of the processor.

18. The processor of claim 1, wherein the request is received via a radio resource control (RRC) message in response to the processor being in a connected mode.

19. The processor of claim 1, wherein the request is received via a paging message in response to the processor being in an inactive mode or idle mode.

20. A method performed by a user equipment (UE), the method comprising:
receiving, from a base station (BS), a request to assist sensing, wherein the request indicates a target area in which the sensing is to be performed; and
transmitting, to the BS, a sensing signal in response to determining to accept the request.
